(19) United States
(12) Patent Application Publication
(10) Pub. No.: US 2021/0166250 A1
(43) Pub. Date: Jun. 3, 2021

(54) DATA PROCESSING METHOD, DEVICE AND STORAGE MEDIUM

(71) Applicant: BEIJING SENSETIME TECHNOLOGY DEVELOPMENT CO., LTD., Beijing (CN)

(72) Inventor: Chen CHEN, Beijing (CN)

(73) Assignee: BEIJING SENSETIME TECHNOLOGY DEVELOPMENT CO., LTD., Beijing (CN)

(21) Appl. No.: 17/134,041

(22) Filed: Dec. 24, 2020

Related U.S. Application Data
(63) Continuation of application No. PCT/CN2020/112704, filed on Aug. 31, 2020.

(30) Foreign Application Priority Data
Nov. 29, 2019 (CN) 201911205440.X

(51) Int. Cl. G06Q 30/02; G06K 9/00

(52) U.S. Cl. CPC G06Q 30/0201; G06K 9/00691; G06Q 30/0205

(57) ABSTRACT

Provided in the embodiments of the present disclosure are a data processing method, device and storage medium. The method comprises: acquiring visit data of a target customer in a group of customers in a target area, wherein the visit data includes location data used for reflecting a location of the target customer and time for generating the location data; determining a residence time duration of the target customer in the target area according to the time for generating the location data; determining data of interest of the target customer based on the residence time duration; and determining the data of interest of the target customer as the data of interest of the group of customers.

### CROSS-REFERENCE TO RELATED APPLICATIONS

The present disclosure is a continuation of and claims priority under 35 U.S.C. § 120 to PCT Application. No. PCT/CN2020/112704, filed on Aug. 31, 2020, which is based on and claims the right of a priority to Chinese Patent Application No. 201911205440.X, filed on Nov. 29, 2019. Each of the above referenced priority documents are incorporated herein by reference in its entirety.

### TECHNICAL FIELD

The present disclosure relates to the technical field of data statistics, and in particular to a data processing method, a device and a storage medium.

### BACKGROUND

In some sales scenarios, such as high-net-worth sales scenarios for automobiles, houses, jewelry, etc., merchants typically provide a statistical analysis of customer visits in order to learn about the popularity of their goods. However, at present, statistics and analysis are performed in units of natural persons. The customers visiting an outlet in relationships such as a couple relationship, a parent relationship, a children relationship, a friend relationship, etc., can be referred to as a group of customers for each relationship. Typically, each group of customers together acquire product information and compare different products, and a sales order is signed for a group of customers as a unit.

Under the above circumstances, statistics and analysis are carried out in units of natural persons, so that data statistics and analysis results are incorrect, which cannot give an accurate feedback on actual purchases of customers. Therefore, there is an urgent need for a data processing method for realizing data collation in units of the groups of visiting customers.

### SUMMARY

The embodiments of the present disclosure are expected to provide a data processing method, a device and a storage medium.

In order to achieve the above object, the technical solution of the embodiment of the present disclosure is realized as follows.

An embodiment of the present disclosure provides a data processing method, which comprises: acquiring visit data of a target customer in a group of customers in a target area, wherein the visit data includes location data for reflecting a location of the target customer and a time for generating the location data; determining a residence time duration of the target customer in the target area according to the time for generating the location data; determining data of interest of the target customer based on the residence time duration; and determining the data of interest of the target customer as data of interest of the group of customers.

An embodiment of the present disclosure also provides a data processing device, which comprises: an acquisition unit, a first determination unit, a second determination unit and a third determination unit, wherein,

the acquisition unit is configured for acquiring visit data of a target customer in the group of customers in a target area, wherein the visit data includes location data for reflecting a location of the target customer and a time for generating the location data,

the first determination unit is configured for determining a residence time duration of the target customer in the target area according to the time for generating the location data,

the second determination unit is configured for determining data of interest of the target customer based on the residence time duration determined by the first determination unit, and

the third determination unit is configured for determining the data of interest of the target customer as data of interest of the group of customers.

An embodiment of the present disclosure also provides a computer-readable storage medium having stored thereon a computer program that, when executed by a processor, implements the steps of the method described in the embodiment of the present disclosure.

An embodiment of the present disclosure also provides a data processing device that includes a memory, a processor, and a computer program stored on the memory and executable on the processor that, when executed, implements the steps of the method described in the embodiment of the present disclosure.

An embodiment of the present disclosure also provides a computer program that causes a computer to execute the data processing method described in the embodiment of the present disclosure.

According to the data processing method, device and storage medium provided in the embodiments of the present disclosure, the method comprises: acquiring visit data of a target customer in a group of customers in a target area, wherein the visit data includes location data for reflecting a location of the target customer and a time for generating the location data; determining a residence time duration of the target customer in the target area according to the time for generating the location data; determining data of interest of the target customer based on the residence time duration; and determining the data of interest of the target customer as data of interest of the group of customers. By adopting the technical solution of the embodiment of the present disclosure, the data of interest of the target customer is determined from the residence time duration of the target customer in the target area, and then the data of interest of the group of customers to which the target customer belongs is determined, so that the data of interest (such as intention or preference) of the group of customers is acquired in a data processing mode, and further the actual purchase of the customers is accurately reflected. Moreover, the data of interest of a specific customer and the target customer is taken as the data of interest of the group of customers to which the target customer belongs, i.e. the data of interest of the target customer can reflect not only the extent of concern of the target customer itself, but also the extent of concern of the group of customers to which the target customer belongs. That is to say, the data of interest of the group of customers is determined by determining the data of interest of the target customer.

### BRIEF DESCRIPTION OF THE DRAWINGS

FIG. 1 is a first flow diagram showing a data processing method according to an embodiment of the present disclosure;

FIG. 2 is a second flow diagram showing a data processing method according to an embodiment of the present disclosure;

FIG. 3 is a third flow diagram showing a data processing method according to an embodiment of the present disclosure;

FIG. 4a is a schematic diagram showing an application scenario of a data processing method according to an embodiment of the present disclosure;

FIG. 4b is a schematic diagram showing another application scenario of a data processing method according to an embodiment of the present disclosure;

FIG. 5 is a first schematic diagram showing the construction of a data processing device according to an embodiment of the present disclosure;

FIG. 6 is a second schematic diagram showing the construction of a data processing device according to an embodiment of the present disclosure;

FIG. 7 is a third schematic diagram showing the construction of a data processing device according to an embodiment of the present disclosure;

FIG. 8 is a fourth schematic diagram showing the construction of a data processing device according to an embodiment of the present disclosure;

FIG. 9 is a schematic diagram showing the hardware construction of a data processing device according to an embodiment of the present disclosure.

### DETAILED DESCRIPTION

The present disclosure will now be described in further details with reference to the accompanying drawings and specific embodiments.

An embodiment of the present disclosure provides a data processing method. FIG. 1 is a first flow diagram showing a data processing method according to an embodiment of the present disclosure. As shown in FIG. 1, the method comprises:

step 101: acquiring visit data of a target customer in a group of customers in a target area, wherein the visit data includes location data for reflecting a location of the target customer and time for generating the location data;

step 102: determining a residence time duration of the target customer in the target area according to the time for generating the location data;

step 103: determining data of interest of the target customer based on the residence time duration; and

step 104: determining the data of interest of the target customer as the data of interest of the group of customers.

The data processing method of the embodiment may be applied to a data processing device, and the data processing device may be a terminal device or a server and the like. Exemplarily, in some sales scenarios, the data processing device may be a terminal device in a sales outlet, or the data processing device may also be a server belonging to a certain brand or an analysis terminal in a brand group that may include multiple sales outlets.

In step 101 of this embodiment, the group of customers is a customer group formed by customers with a particular relationship. This particular relationship may be at least one of the following: a couple relationship, a parent relationship, a children relationship, a friend relationship and the like. For example, two customers in a couple relationship may serve as a group of customers; two customers in a parent-child relationship may serve as a group of customers, several customers in a friend relationship may serve as a group of customers, etc.

The data processing method of the embodiment is applied in certain sales scenarios, for example, high-net-worth sales scenarios such as automobile sales scenario, house sales scenario, jewelry sales scenario and the like. In these sales scenarios, the group of customers consisting of a plurality of customers in the above-described particular relationships arrives together at the sales location in most cases, and typically this group of customers signs a sales order. There is usually a decision maker in the group of customers, the intention of this decision maker usually determines the intention of the whole group of customers and further determines whether or not the sales order can be signed. Therefore, the target customer in the group of customers in this embodiment is the decision maker in the group of customers. According to the embodiment, the data of the target customer (i.e. the decision maker) in the group of customers is mainly acquired, and the data of the target customers is analyzed to determine the data of interest of the target customer, and the data of interest of the target customer is taken as the data of interest of the group of customers to which the target customer belongs.

In some implementations, a target customer in a group of customers may be determined by a designated salesperson assigned to this group of customers by a target site. For example, when a group of customers visits an automobile sales outlet, a salesperson is typically assigned to the group of customers each of which will be served by this salesperson throughout their stay in the automobile sales outlet, and the salesperson will introduce various automobiles in the automobile sales outlet to the customers. In this case, the target customer in the group of customers can be determined by the salesperson and relevant information about the target customer can be obtained, and the relevant information may include information about target customer's age, gender, whether the target customer is a new customer or not (i.e., whether he/she visits the target site for the first time), contact information, etc.

In step 101 of this embodiment, the visit data characterizes the data within the target area of the target site where the target customer in the group of customers visits, wherein the target site is a site containing at least one target area, and each target area may correspond to one target object, i.e. the target site is a site containing at least one target object. For example, for an automobile sales outlet in which automobiles of various models to be sold are parked, these automobiles can serve as target objects, the areas where the automobiles are parked are the target areas, and the automobile sales outlet is the target site.

Wherein the target area is an area related to the target object. As an implementation, the target area is an area where the target object is located. For example, the target site is a house sales site in which sample rooms for various types of houses may be provided, and an area in which the sample room for each type of house is located may serve as the target area. As another implementation, the target area is an area larger than that where the target object is located, i.e. the target area includes an area where the target object is located and an area around the target object with a distance from the target object being smaller than a preset distance threshold. For example, the target site is an automobile sales site, automobiles of various models are parked in the automobile sales site, the parking area of each automobile includes the area where the automobile is located and is larger than the area where the automobile is located, so that a customer can observe around the automobile and can also experience sitting in the automobile. In this case, the automobile parking area which includes the area where the automobile is located and which is larger than the area where the automobile is located can serve as the target area. It will be appreciated that the target areas corresponding to different target objects may be divided in the same or different ways, and generally the target areas corresponding to different target objects are different.

Wherein the visit data includes location data for reflecting a location of the target customer and time for generating the location data; the location data indicates the location of the target customer in the target site. Exemplarily, the location data may be represented by latitude and longitude coordinates, or may be determined by a relative location relationship to a reference, and the manner in which the location data is represented is not limited and may include, but is not limited to, those enumerated above.

In some alternative embodiments of the present disclosure, acquiring visit data of the target customer in the group of customers in the target area comprises: acquiring visit data of the target customer; and acquiring, from the visit data of the target customer, the visit data the location data of which indicates that the target customer is located in the target area, as the visit data of the target customer in the target area.

In an alternative embodiment, the visit data includes message data; acquiring the visit data of the target customer comprises: acquiring at least one target message data carrying an identification of the target customer; acquiring, from the visit data of the target customer, the visit data the location data of which indicates that the target customer is located in the target area, as the visit data of the target customer in the target area, comprises: extracting the location data of the target customer from the target message data; and taking the target message data in which the location data is within the target area, as the visit data of the target customer in the target area.

In this embodiment, the message data can be sent out by a terminal device, and the message data can include the identification of the customer, the location data of the customer and the time for generating the location data. As an example, after a salesperson determines a target customer in a group of customers, a terminal device may be assigned to the target customer, and the terminal device transmits the message data either in real-time or periodically by the side of the target customer. As another example, after a salesperson determines a target customer in a group of customers, a terminal device may be assigned to the target customer, and the terminal device transmits the message data in real-time by the side of the salesperson. Since the salesperson explains and introduces for the target objects in the target site while following the target customer, the salesperson gets closer to the target customer. In this scenario, the location data included in the message data may represent an approximate location of the target customer, which is equivalent to the location of the target customer. Wherein, the identification of the target customer is a unique identification assigned to the target customer; exemplarily, the identification of the target customer is an ID of the target customer. The target message data is message data corresponding to the target customer, in message data corresponding to a plurality of customers. It will be appreciated that the visit data may include a plurality of message data corresponding to a plurality of customers, e.g., message data for customer A, message data for customer B, etc., among the plurality of message data; and if the customer A is the target customer, the message data for the customer A is taken as the target message data.

In some alternative embodiments, acquiring at least one target message data carrying an identification of the target customer comprises: acquiring at least one target message data carrying an identification of the target customer from cached message data corresponding to a plurality of customers; or receiving the message data corresponding to a plurality of customers and discarding the message data carrying no identification of the target customer from the message data corresponding to a plurality of customers, so as to acquire at least one target message data carrying the identification of the target customer.

In practical applications, as the transmission interval of the message data is short (for example, one message data can be transmitted every three seconds), there might be a problem of larger data amount of the message data. Therefore, in some implementations, the message data can be cached at first and then at least one target message data carrying the identification of the target customer is extracted from the cached message data according to a set rule. Exemplarily, at least one target message data carrying the identification of the target customer may be extracted from the cached message data in a timing manner, i.e., in each processing time period set in each day. In other implementations, processing conditions may also be set, and for example, the processing conditions are used for processing the data for a particular target customer, such as setting an identification of the target customer; the data processing device can receive the message data in real-time, screen the received message data based on the set identification of the target customer, discard the message data carrying no identification of the target customer, and merely store at least one target message data carrying the identification of the target customer for subsequent uses.

In another alternative embodiment, the visit data includes a personal image of the target customer; acquiring visit data of the target customer comprises: acquiring at least one frame of personal image of the target customer captured by an image capturing device. Acquiring, from the visit data of the target customer, the visit data the location data of which indicates that the target customer is located in the target area as the visit data of the target customer in the target area comprises: acquiring a deployment location of the image capturing device and a location of the target customer in the personal image; determining location data of the location of the target customer according to the deployment location of the image capturing device and the location of the target customer in the personal image; and taking a personal image corresponding to which the location data is within the target area as the visit data of the target customer in the target area.

In this embodiment, the visit data can be sent out by a terminal device. The visit data includes a personal image containing the target customer. As an implementation, the terminal device may be an image capturing device; as another implementation, the terminal device may also be a computer terminal device that may obtain a personal image containing the target customer from an image capturing device, and the computer terminal device may be electrically or wirelessly communicatively connected to the image capturing device in order to obtain, through the electrical or wireless communication connection, the personal image captured by the image capturing device. Specifically, the image capturing device may be a camera deployed in a wall or a ceiling, and the image capturing area of the camera includes a target area; the fixed location of the camera in the wall or ceiling is the deployment location of the image capturing device. Exemplarily, the deployment location of the image capturing device may be longitude and latitude coordinates fixed at the wall or ceiling.

Of course, the deployment location of the image capturing device may also change over time or on demand, e.g., some image capturing devices may be mobile image capturing devices, or in other scenarios such as promotions, some image capturing devices may be temporarily used image capturing devices, etc. Under the above circumstances, the location of the image capturing device in the process of capturing the personal image by the image capturing device can be determined as the above deployment location.

In this embodiment, the data processing device can carry out face recognition on the image captured by the image capturing device, in order to determine personal images including a face from multiple frames of images, and then determine the personal image including a target customer from the personal images; and the location of the target customer in the personal image is further determined, wherein the location of the target customer in the personal image is relative location data. For example, a planar coordinate system is established by using the personal image, and assuming that the lower right corner of the personal image serves as the origin of the planar coordinate system, the location of the target customer in the personal image can be represented by the coordinates of the midpoint of the target customer in the planar coordinate system. Since at least one frame of the personal image of the target customer is obtained by an image capturing device (such as camera) arranged corresponding to the target area, the location (i.e. relative location data) of the target customer in the personal image can also indicate the relative location data of the target object and the image capturing device; the location data of the target customer is further determined based on the relative location data and the deployment location of the image capturing device. The deployment location of each image capturing device deployed in a target site can be preconfigured in the data processing device.

In some implementations, acquiring the location of the target customer in the personal image comprises: determining relative location data of the target customer in the image in the personal image based on the personal image and a preset network model.

In this embodiment, the preset network model can carry out feature extraction processing on the personal image containing the target customer, and determine the relative location data of the head or the upper half body of the target customer in the personal image based on the extracted features. Further, since the deployment location of the image capturing device is fixed and the angle of view of the image capturing device is also fixed (the angle of view of the image capturing device corresponds to the target area), the location data of the target customer, such as the longitude and latitude data of the target customer, can be determined based on the relative location data of the target customer in the personal image and the deployment location of the image capturing device.

In this implementation, acquiring at least one frame of personal image of the target customer captured by the image capturing device comprises: carrying out face recognition on cached personal images corresponding to a plurality of customers, and determining at least one frame of personal image corresponding to the target customer, from the plurality of personal images.

In this embodiment, since the amount of the image data captured by the image capturing device is large, the image data of the customers can be cached at first, and then face recognition is carried out on the cached image data to determine the personal image of the target customer. Exemplarily, a personal image corresponding to each target customer may be identified by performing face recognition on the cached images in a timing manner, i.e., at the expiration of the processing time set in each day. Alternatively, the processing condition may be set, for example, the set processing condition is a certain target customer, and at the expiration of the processing time, face recognition is performed on the cached image to identify a personal image corresponding to the certain target customer.

In practical applications, an image of a target customer may be captured as a reference image when a group of customers arrives at the target site and a salesperson at the target site determines the target customer in this group of customers and obtains relevant information about the target customer. A feature extraction is carried out on the reference image through a face recognition network model to obtain reference features, and a feature extraction is carried out on the cached personal image to obtain image features; the reference features are compared with the image features; and if the reference features are consistent with the image features, then the corresponding image can be determined as the personal image of the target customer.

In this embodiment, no matter whether the first implementation is used (i.e., the visit data includes the message data) or the second implementation is used (i.e., the visit data includes the personal image of the target customer), the location data of the location where the target customer is located is obtained. The target area represents an area range, whether the target customer is located in the target area, i.e. whether the location of the target customer is in the target area.

Exemplarily, in the case where the location data of the target customer is represented by latitude and longitude coordinates, the target area may be represented by a latitude and longitude coordinate range. Then, determining whether the target customer is located in the target area comprises: judging whether longitude coordinates in the location data of the target customer are in the longitude coordinate range of the target area, and judging whether latitude coordinates in the location data of the target customer are in the latitude coordinate range of the target area; in the case where the longitude coordinates in the location data of the target customer are in the longitude coordinate range of the target area and the latitude coordinates in the location data of the target customer are in the latitude coordinate range of the target area, determining that the target customer is in the target area; in the case where the longitude coordinates in the location data of the target customer are not in the longitude coordinate range of the target area and/or the latitude coordinates in the location data of the target customer are not in the latitude coordinate range of the target area, determining that the target customer is not in the target area.

In step 102 of this embodiment, the residence time duration of the target customer in the target area characterizes the stay time duration of the target customer in the target area, i.e., the duration of the location of the target customer in the target area.

In an alternative embodiment of the present disclosure, with respect to step 102, the at least one target message data includes a plurality of target message data; determining a residence time duration of the target customer in the target area according to the time for generating the location data comprises: determining at least two target message data in the plurality of target message data, wherein the at least two target message data include first target message data and second target message data, and the time for generating the location data in the first target message data is earlier than the time for generating the location data in the second target message data; determining the residence time duration according to the time for generating the location data in the first target message data and the time for generating the location data in the second target message data; wherein the location data carried by the first target message data is different from the location data carried by a previous target message data adjacent to the first target message data; the location data carried by the second target message data is different from the location data carried by a next target message data adjacent to the second target message data; and the location data carried by the first target message data is the same as the location data carried by the second target message data.

In this embodiment, the plurality of target message data is message data of the target customer. Since the target message data carries the location data of the target customer, the at least two target message data may be target message data corresponding to the same location data. The location data being the same indicates that the location where the target customer is located belongs to the same target area, and similarly, the location data being different indicates that the location where the target customer is located belongs to different target areas. For example, if the location data carried by one message data indicates that the location where the target customer is located is in a target area and the location data carried by another message data indicates that the location where the target customer is located is not in the target area (e.g. the location where the target customer is located is in another target area), it may be determined that the location data carried by the two target message data are different.

In this embodiment, the at least two target message data may be target message data which are continuously received by the data processing device and carry the same location data. Then, the first target message data may be the first target message data in the at least two target message data, and the second target message data may be the last target message data in the at least two target message data. It can be understood that within a time range from entrance of the target customer into the target area to exit from the target area, the first obtained target message data is used as the first target message data, and the last target message data is used as the second target message data. According to the time for generating the location data in the first target message data (recorded as time 1) and the time for generating the location data in the second target message data (recorded as time 2), the time duration corresponding to the time range between the time 2 and the time 1 is taken as the residence time duration.

In another alternative embodiment of the present disclosure, with respect to step 102, the at least one target message data includes a plurality of target message data, the target message data includes first message data; determining the residence time duration of the target customer in the target area according to the time for generating the location data comprises: continuously obtaining the plurality of target message data corresponding to the target customer, and determining first location data of the target customer respectively based on each target message data in the plurality of target message data; in the case where at least part of the first location data in a plurality of the first location data indicates that the target customer is located in the target area, determining a plurality of first message data corresponding to the at least part of the first location data; and determining the residence time duration of the target customer in the target area based on a transmission time interval of two adjacent first message data in the plurality of first message data.

In this embodiment, the data processing device can obtain a plurality of target message data corresponding to the target customer; each target message data carries first location data of a target customer; in the case where at least part of the first location data in the obtained plurality of first location data indicates that the target customer is located in the target area, the residence time duration of the target customer in the target area is determined based on the time interval of two adjacent first message data in the first message data corresponding to the at least part of the first location data.

As an example, a plurality of first message data corresponding to the at least part of the first location data may be continuously obtained, the transmission interval of two adjacent first message data may be extremely small. Exemplarily, the transmission interval may be 3 seconds, but the transmission interval in this embodiment may not be limited to the above example, and other values are within the scope of protection of the present embodiment as well. The residence time duration can be determined according to the intervals of two adjacent first message data in the plurality of first message data. For example, the transmission intervals of two adjacent first message data are accumulated together, and the result of accumulation is taken as the residence time duration. That means that during accumulation of the transmission intervals, once there is message data different from the location data carried by the previous message data, the transmission interval accumulation process is ended. The result of accumulation until the end of the accumulation process is the residence time duration.

As another example, a plurality of first message data corresponding to the at least part of the first location data may not be obtained continuously. For example, at a certain time, the data processing device obtains target message data corresponding to the target customer, the target message data includes first location information of the target customer, and the first location information is in a first target area; at the next time, the first location information of the target customer included in the obtained target message data is in a second target area; and at another time, the first location information of the target customer included in the obtained target message data is also in the first target area. In such scenario, a plurality of message data corresponding to the same target object (such as the first target object) are discontinuous. The reasons for such scenario may include for example obstructed communication link (for example, a communication signal is weak or blocked by an obstacle). Even if a sending side of the message data can send the message data according to a set transmission interval, the data processing device may still not completely receive the message data, and message data missing might be occurred. For another example, a target customer moves into a target area of a target object at a certain time, and at this time the data processing device obtains target message data corresponding to the target customer; however, the target customer only passes by the target area and immediately leaves the target area, so that the first location data in the target message data corresponding to the target customer obtained at the next time is not in the target area. The target customer might move into the target area again at a later time, then the data processing device obtains the target message data of this target customer again at a certain time, and the first location data in the target message data is in the target area.

In order to obtain more accurate residence time duration under the above circumstances, a first threshold value can be introduced to estimate whether the time intervals of two adjacent first message data are accumulated or not. Therefore, in some embodiments, determining the residence time duration of the target customer in the target area based on the time intervals of two adjacent first message data in the plurality of first message data comprises: determining, from the plurality of first message data, at least part of the first message data in which the time interval between two adjacent first message data is smaller than the first threshold value, and determining the residence time duration based on the time interval between two adjacent first message data in the at least part of the first message data.

In this embodiment, the first threshold value is preset, and in the case where the obtained time intervals of two adjacent message data are smaller than the first threshold value, the time intervals of the two adjacent first message data are accumulated, and the result of accumulation is taken as the residence time duration; it should be noted that the first location data in the two adjacent first message data are the same, i.e. the first location data in the two adjacent first message data indicate that both are within the same target area. Correspondingly, if the time intervals of the two adjacent first message data are greater than or equal to the first threshold value, the time intervals of the two adjacent first message data are not accumulated.

In this embodiment, there are different types of target objects corresponding to the target area. As an example, the target object is the target site itself, or an object provided in the target site. Considering that the larger the target area is, the longer the time the target customer takes to leave the target area. Therefore, in this embodiment, different first threshold values may be set for different target objects, that is, the sizes of the target areas corresponding to the target objects. The first threshold value can be positively correlated with the size of a target area corresponding to the target object.

Exemplarily, an automobile sales outlet is taken, for example, as the target site. If the target object is the automobile sales outlet itself, the first threshold value may be, for example, 20 minutes. If the target object is a certain automobile in the automobile sales outlet, the first threshold value may be, for example, 5 minutes. Of course, the first threshold value in the embodiment of the present disclosure is not limited to the above example, and other values may be within the scope of protection of the present embodiment as well.

In step 103 of this embodiment, data of interest of the target customer is obtained through statistical analysis of the obtained residence time durations. In some alternative embodiments, there are a plurality of target areas, and each target area characterizes an area corresponding to one target object; determining the data of interest of the target customer based on the residence time duration comprises: obtaining the residence time duration of the target customer in each target area; wherein the residence time duration includes the residence time duration of the target customer in the target area corresponding to at least one time period; ranking the residence time durations corresponding to a plurality of target areas, and determining first data of interest of the target customer based on the ranking result, wherein the first data of interest characterizes the extent to which a plurality of target objects are concerned by the target customer.

In this embodiment, the residence time durations of the same target customer in a plurality of target areas corresponding to a plurality of target objects are ranked from longest to shortest, and the extent to which the plurality of target objects are concerned by the target customer is determined according to the ranking result. The plurality of target objects are objects of the same type. For example, the plurality of target objects are automobiles of different models in an automobile sales outlet, etc. This embodiment determines the extent to which the plurality of target objects are concerned by the target customer on the premise of the same type of target objects.

Wherein, the amount of the residence time duration indicates the extent to which the corresponding target objects are concerned. The longer the residence time duration is, the more the extent to which the corresponding target objects are concerned; the shorter the residence time duration is, the less the extent to which the corresponding target objects are concerned. For example, the target customer resides within the target area of the target object 1 for 10 minutes and within the target area of target object 2 for 20 minutes, and this may indicate that the target customer is more interested in or prefers target object 2. As an example, the data processing device may rank the plurality of residence time durations corresponding to the above plurality of target areas (target objects) from longest to shortest and select the target objects corresponding to the first N (N is a positive integer, e.g., N may be 2) residence time durations. This indicates that the target customer (including the group of customers to which the target customer belongs) is more interested in the selected first N target objects. In terms of the extent of concern, the higher the ranking is, the more the concern would be.

The time period may specifically be a date. That is to say, the residence time durations of the target customer in each target area on one date are respectively counted, or the residence time durations of the target customer in each target area on multiple dates are counted respectively (equivalent to the accumulated residence time duration obtained by accumulating the residence time durations in each target area on each date respectively). For example, on a certain day, a target customer resides in a target area of the target object 1 in a target site for 10 minutes and in a target area of the target object 2 for 15 minutes; on another day, the target customer resides in the target area of the target object 1 in the same target site for 10 minutes and in the target area of the target object 2 for 15 minutes. Then, the accumulated residence time duration of the target customer in the target area of the target object 1 is 20 minutes, and the accumulated residence time duration in the target area of the target object 2 is 30 minutes.

By adopting the technical solution of the embodiment of the present disclosure, the data of interest of the target customer is determined from the residence time duration of the target customer in the target area, and then the data of interest of the group of customers to which the target customer belongs is determined, so that the data of interest (such as intention or preference) of the group of customers is acquired in a way of data processing, and further the actual purchase of the customers is accurately reflected. Moreover, the data of interest of a specific customer and the target customer are taken as the data of interest of the group of customers to which the target customer belongs. That is, the data of interest of the target customer can reflect not only the extent of concern of the target customer itself, but also the extent of concern of the group of customers to which the target customer belongs. That is to say, the data of interest of the group of customers is determined by determining the data of interest of the target customer.

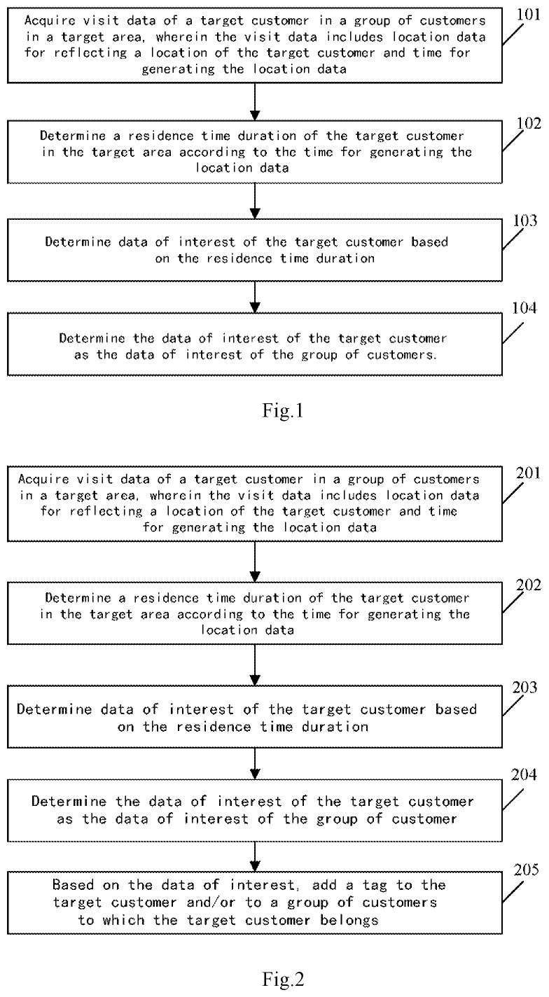

An embodiment of the present disclosure also provides a data processing method. FIG. 2 is a second flow diagram showing a data processing method according to an embodiment of the present disclosure. As shown in FIG. 2, the method comprises:

step 201: acquiring visit data of a target customer in a group of customers in a target area, wherein the visit data includes location data for reflecting a location of the target customer and time for generating the location data;

step 202: determining a residence time duration of the target customer in the target area is determined according to the time for generating the location data;

step 203: determining data of interest of the target customer based on the residence time duration;

step 204: determining the data of interest of the target customer as the data of interest of the group of customers; and

step 205: adding, based on the data of interest, a tag to the target customer and/or to a group of customers to which the target customer belongs.

Steps 201 to 204 of this embodiment may be described in details with reference to steps 101 to 104 of the foregoing embodiment, and shall not be described in details herein.

In this embodiment, the data processing device may determine a target object concerned by the target customer based on the data of interest of the target customer (e.g., the first data of interest in the previous embodiment), e.g., determine the target object having the longest target customer residence time duration, and use the target object as a tag corresponding to the target customer and/or the group of customers to which the target customer belongs, or use the type to which the target object having the longest residence time duration belongs as a tag corresponding to the target customer and/or the group of customers to which the target customer belongs. The type to which the target object belongs may be pre-divided based on the price of the target object. For example, for automobiles, the automobiles can be divided into several price ranges according to their prices, each price range can be correspondingly provided with a type identification, the price corresponding to a target object concerned by a target customer can be determined firstly, the price range corresponding to the price can be determined, then the type identification corresponding to the price range can be determined, and the type identification can be used as a tag for the target customer and/or the group of customers to which the target customer belongs. Thus, the salesperson may determine, from the tag, the desired price for the target customer and/or the group of customers to which the target customer belongs, and may recommend automobiles of the same type for the target customer and/or the group of customers to which the target customer belongs during the sale.

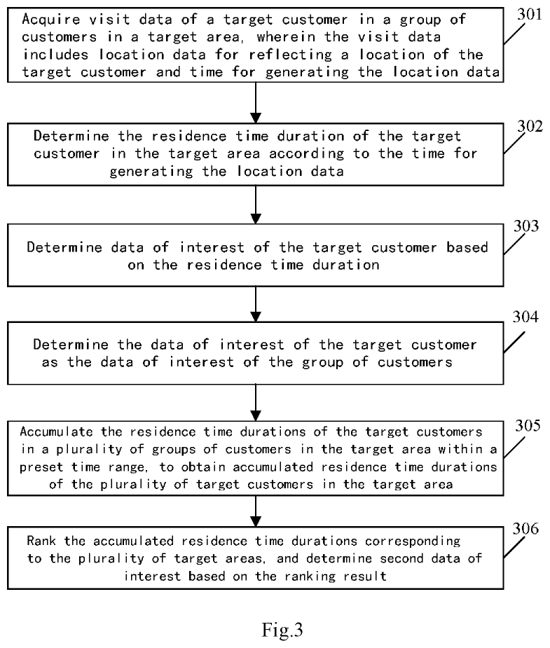

An embodiment of the present disclosure also provides a data processing method. FIG. 3 is a third flow diagram showing a data processing method of an embodiment of the present disclosure. As shown in FIG. 3, the method comprises:

step 301: acquiring visit data of a target customer in a group of customers in a target area, wherein the visit data includes location data for reflecting a location of the target customer and time for generating the location data;

step 302: determining the residence time duration of the target customer in the target area according to the time for generating the location data, wherein there are a plurality of the target areas, and each target area characterizes an area corresponding to one target object;

step 303: determining data of interest of the target customer based on the residence time duration;

step 304: determining the data of interest of the target customer as the data of interest of the group of customers;

step 305: accumulating the residence time durations of the target customers in a plurality of groups of customers in the target area within a preset time range, to obtain accumulated residence time durations of a plurality of the target customers in the target area;

step 306: ranking the accumulated residence time durations corresponding to the plurality of target areas, and determining second data of interest based on the ranking result, wherein the second data of interest respectively characterizes the extent to which the target object corresponding to each of the plurality of target areas is concerned.

Steps 301 to 304 of this embodiment may be described in details with reference to steps 101 to 104 of the foregoing embodiment, and shall not be described in details herein.

This embodiment enables data processing with respect to an extent to which a target object is concerned. Specifically, there are a plurality of target areas within a target site, each target area corresponding to one target object. There are a plurality of groups of customers (including target customers) which have visited target site. The residence time durations of each target customer in one or more target areas are accumulated respectively to obtain an accumulated residence time duration of the plurality of target customers in each target area. For example, on a certain day, 10 target customers reside in a target area, and the accumulated residence time duration of the 10 target customers is 120 minutes; 15 target customers reside in another target area, and the accumulated residence time duration of the 15 target customers is 250 minutes.

Then in this embodiment, the accumulated residence time durations corresponding to the various target areas are ranked from longest to shortest, and the second data of interest is determined based on the ranking result. The accumulated residence time duration indicates an extent to which the corresponding target object is concerned; the longer the accumulated residence time duration is, the more the extent to which the corresponding target object is concerned; the shorter the accumulated residence time duration is, the less the extent to which the corresponding target object is concerned. In the same way, a target area of one target object has an accumulated residence time duration of 120 minutes and a target area of another target object has an accumulated residence time duration of 250 minutes, and this may indicate that the extent to which the another target object is concerned is higher than the extent to which the one target object is concerned, i.e. the another target object is more popular.

The preset time range may be a certain time range in one day, or a day, or a time range resulting from accumulation of multiple days, or the like.

Based on the above-mentioned embodiments, in some alternative embodiments of the present disclosure, after determining of the data of interest of the target customer as the data of interest of the group of customers, the method further comprises: receiving an access request for data of interest of a plurality of groups of customers; and in response to the access request, presenting the data of interest of the plurality of groups of customers through a display screen according to a presentation mode indicated by the access request.

The data processing device in this embodiment can receive an input operation of a user, wherein the input operation is used for accessing the data of interest; an access request for a plurality of groups of customers (or target customers in the plurality of groups of customers) is obtained in response to the input operation, wherein the access request is used to present the data of interest of the plurality of groups of customers (or target customers in the plurality of groups of customers). The data processing device can present the data of interest of the plurality of groups of customers through the display screen according to the presentation mode indicated by the access request. The presentation mode may be at least one of: a graphics presentation mode, a table presentation mode and the like. The graphics presentation mode includes, but is not limited to, a histogram presentation mode, a graph presentation mode, a scatter diagram presentation mode and the like. The graphics presentation mode in this embodiment is not specifically limited.

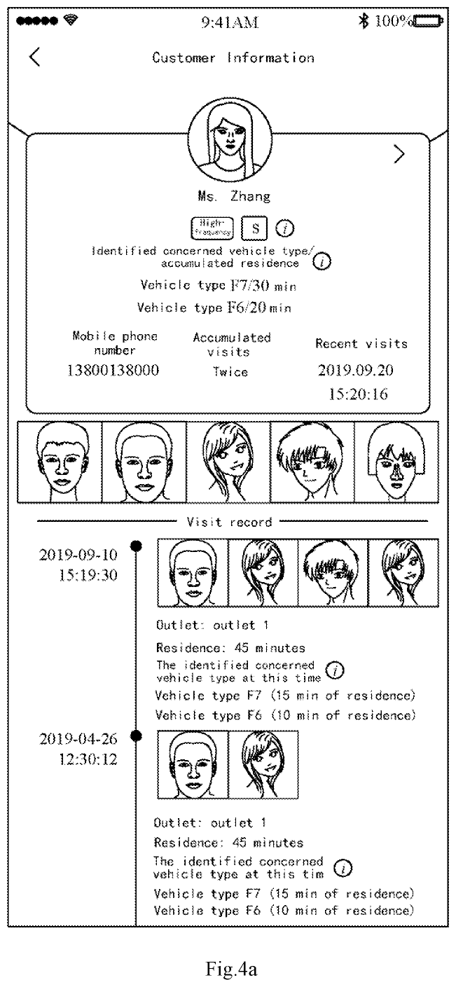

The data processing method of the embodiment of the present disclosure can be applied to a variety of application scenarios. FIG. 4a is a schematic view showing an application scenario of a data processing method of an embodiment of the present disclosure. FIG. 4b is a schematic view showing another application scenario of a data processing method of an embodiment of the present disclosure. As shown in FIG. 4a, Ms. Zhang is a target customer (i.e. a decision maker) of a group of customers, and information about her and the group of customers to which she belongs can be collected. In the process of data presentation, referring to FIG. 4a, the data of the customer, i.e. the data of the target customer, can be presented in units of the group of customers. Two visits to the outlet 1, fellows during each visit and the like are shown in FIG. 4a. According to the solution described in the data processing method in the embodiment of the present disclosure, whether the location data is in a target area of a certain target object is determined by determining the location data of Ms. Zhang; in the case where the location data is in the target area, the residence time duration of the target customer in the target area is determined. In this example, it can be determined that Ms. Zhang and the group of customers to which she belongs reside in the target area where vehicle type F7 is located and also reside in the target area where vehicle type F6 is located. During the first visit and the second visit, the residence time duration in the target area where vehicle type F7 is located is 15 minutes and the residence time duration in the target area where vehicle type F6 is located is 10 minutes. That is, the accumulated residence time duration for vehicle type F7 is 30 minutes, and the accumulated residence time duration for vehicle type F6 is 20 minutes. It can be determined from the above data statistics that: the target object concerned most by Ms. Zhang is the vehicle type F7. Referring to the data of Ms. Zhang, this data can be determined as the data of the group of customers to which Ms. Zhang belongs, that is, the target object concerned most by the group of customers to which Ms. Zhang belongs is the vehicle type F7.

As shown in FIG. 4b, if the accumulated residence time duration is calculated for all vehicle types in the outlet 1, the accumulated residence time duration for each vehicle type as shown in FIG. 4b can be determined.

In practical applications, due to large data amount, the stored message data can be processed in such a manner that it is stored at first and then processed either in a timing manner or on demand.

As an implementation, the visit data of a certain day can be selected for processing, the accumulated residence time duration of each vehicle type in a certain store during this day is determined, and the vehicle type popularity ranking list shown in FIG. 4b is obtained after ranking.

As another implementation, visit data at a certain time of the day can be selected for processing on demand, the visit data at a certain time refers to visit data obtained within a time range from 0:00 a.m. to this time of that day, the accumulated residence time duration of each vehicle type in a certain outlet within this time range is determined, and the vehicle type popularity ranking list within this time range is obtained after ranking.

As yet another implementation, visit data within a time range can be selected for processing on demand, the accumulated residence time duration of each vehicle type in a certain outlet within this time range is determined, and the vehicle type popularity ranking list within this time range is obtained after ranking.

In FIG. 4b, the number of target customers (or groups of customers) during each time period of a certain day may also be determined based on timestamps in the visit data or the time at which the visit data is obtained.

According to this embodiment, statistical analysis can be carried out on the basis of the information collection of the target customer (which may include other customers in the group of customers where the target customer belongs) in units of the groups of customers. Among the groups of customers, the data of the target customer can often represent the situation of each customer in the group of customers, that is, the data of the target customer can serve as the data of the group of customers to which the target customer belongs.

For example, in FIG. 4b, the selected presentation mode is to give a presentation on a decision-maker basis, so that the real-time passenger flow quantity reflects the real-time passenger flow of the decision maker, that is, the real-time passenger flow of the target customer, and the real-time passenger flow of the target customer can also be regarded as the real-time passenger flow of the group of customers. Therefore, a salesperson and the like can conveniently and intuitively know about the visit of each group of customers. Likewise, the outlet vehicle type popularity ranking list may also be the one determined based on the target customer, i.e., an outlet vehicle type popularity ranking list obtained in units of the group of customers.

It thus can be seen that by adopting the technical solution provided in the embodiment of the present disclosure, the relevant data of the group of customers to which the target customer belongs can be obtained by having a grasp of the relevant data of the target customer. Therefore, in the high-net-worth sales scenario, based on the data collation results obtained in units of groups, the data amount required for data collation can be effectively reduced (namely, the data of the target customer in the group of customers is collated), and better service is provided for each group of customers.

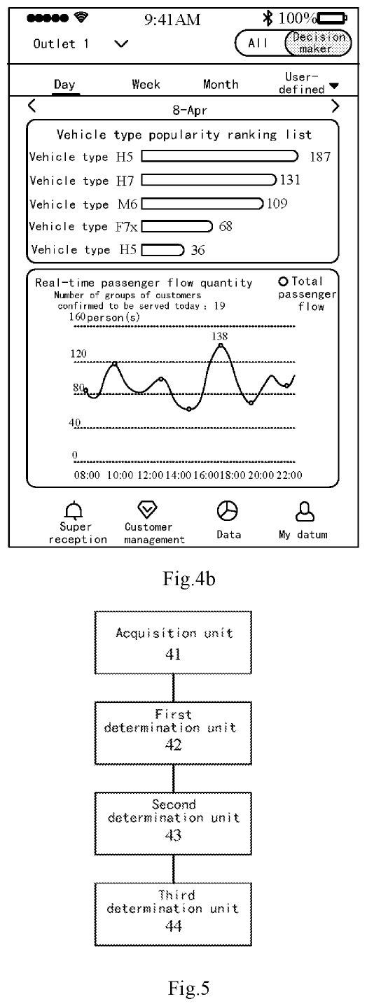

An embodiment of the present disclosure also provides a data processing device. FIG. 5 is a schematic diagram showing the construction of a data processing device according to an embodiment of the present disclosure. As shown in FIG. 5, the device includes: an acquisition unit 41, a first determination unit 42, a second determination unit 43 and a third determination unit 44.

The acquisition unit 41 is configured for acquiring visit data of a target customer in a group of customers in a target area, wherein the visit data includes location data for reflecting a location of the target customer and time for generating the location data.

The first determination unit 42 is configured for determining a residence time duration of the target customer in the target area according to the time for generating the location data.

The second determination unit 43 is configured for determining data of interest of the target customer based on the residence time duration determined by the first determination unit 42.

The third determination unit 44 is configured for determining the data of interest of the target customer as the data of interest of the group of customers.

In an alternative embodiment of the present disclosure, the acquisition unit 41 is configured for: acquiring visit data of the target customer; and acquiring, from the visit data of the target customer, the visit data the location data of which indicates that the target customer is located in the target area, as the visit data of the target customer in the target area.

In an alternative embodiment of the present disclosure, the visit data includes message data. The acquisition unit 41 is configured for: acquiring at least one target message data carrying an identification of the target customer; extracting the location data of the target customer from the target message data; and taking the target message data in which the location data is within the target area, as the visit data of the target customer in the target area.

In an alternative embodiment of the present disclosure, the visit data includes a personal image of the target customer. The acquisition unit 41 is configured for: acquiring at least one frame of personal image of the target customer captured by the image capturing device; acquiring a deployment location of the image capturing device and a location of the target customer in the personal image; determining location data of the location of the target customer according to the deployment location of the image capturing device and the location of the target customer in the personal image; and taking a personal image corresponding to which the location data is within the target area as the visit data of the target customer in the target area.

In an alternative embodiment of the present disclosure, the acquisition unit 41 is configured for: acquiring at least one target message data carrying an identification of the target customer from cached message data corresponding to a plurality of customers; or receiving message data corresponding to the plurality of customers, and discarding the message data carrying no identification of the target customer from the message data corresponding to the plurality of customers, so as to obtain at least one target message data carrying the identification of the target customer.

In an alternative embodiment of the present disclosure, the at least one target message data includes a plurality of target message data.

The first determination unit 42 is configured for: determining at least two target message data in the plurality of target message data, wherein the at least two target message data includes first target message data and second target message data, and the time for generating the location data in the first target message data is earlier than the time for generating the location data in the second target message data; determining the residence time duration according to the time for generating the location data in the first target message data and the time for generating the location data in the second target message data; wherein the location data carried by the first target message data is different from the location data carried by a previous target message data adjacent to the first target message data; the location data carried by the second target message data are different from the location data carried by a next target message data adjacent to the second target message data; and the location data carried by the first target message data is the same as the location data carried by the second target message data.

In an alternative embodiment of the present disclosure, the at least one target message data includes a plurality of target message data, and the target message data includes first message data. The first determination unit 42 is configured for continuously obtaining the plurality of target message data corresponding to the target customer, and respectively determining first location data of the target customer on the basis of each target message data in the plurality of target message data; in the case where at least part of the first location data in the plurality of first location data indicates that the target customer is located in the target area, determining a plurality of first message data corresponding to the at least part of the first location data; and determining the residence time duration of the target customer in the target area based on time intervals of two adjacent first message data in the plurality of first message data.

In an alternative embodiment of the present disclosure, the first determination unit 42 is configured for determining, from the plurality of first message data, at least part of the first message data for which the time interval between two adjacent first message data is less than a first threshold value, and determining the residence time duration based on the time interval between two adjacent first message data in the at least part of the first message data.

In an alternative embodiment of the present disclosure, there are a plurality of target areas, and each target area characterizes an area corresponding to one target object; the second determination unit 43 is configured for obtaining the residence time durations of the target customer in each target area respectively; the residence time duration includes the residence time duration of the target customer in the target area corresponding to at least one time period; the residence time durations corresponding to a plurality of target areas are ranked, first data of interest of the target customer is determined based on the ranking result, and the first data of interest characterizes the extent to which a plurality of target objects are concerned by the target customer.

In an alternative embodiment of the present disclosure, there are a plurality of target areas, and each target area characterizes an area corresponding to one target object; as shown in FIG. 6, the device further includes a fourth determination unit 45, which is configured for accumulating the residence time durations of the target customers in a plurality of groups of customers in the target area within a preset time range, to obtain accumulated residence time durations of the plurality of target customers in the target area; ranking the accumulated residence time durations corresponding to the plurality of target areas, and determining second data of interest based on the ranking result, wherein the second data of interest respectively characterizes the extent to which the target object corresponding to each of the plurality of target areas is concerned.

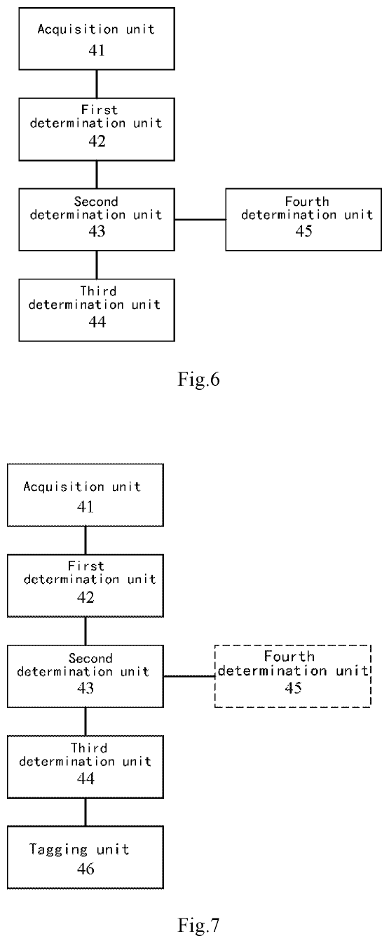

In an alternative embodiment of the present disclosure, as shown in FIG. 7, the device further includes a tagging unit 46, which is configured for adding a tag to the target customer and/or the group of customers to which the target customer belongs based on the first data of interest.

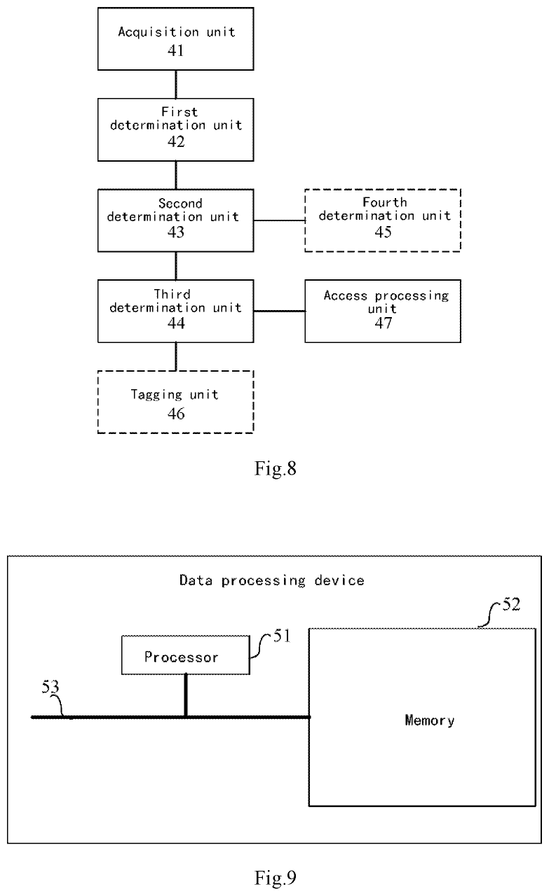

In an alternative embodiment of the present disclosure, as shown in FIG. 8, the device further includes an access processing unit 47, which is configured for receiving an access request for data of interest of a plurality of groups of customers; and in response to the access request, presenting the data of interest of the plurality of groups of customers through a display screen according to a presentation mode indicated by the access request.

In the embodiment of the present disclosure, in practical applications, the acquisition unit 41, the first determination unit 42, the second determination unit 43, the third determination unit 44, the fourth determination unit 45, the tagging unit 46 and the access processing unit 47 in the data processing device may be implemented by a Central Processing Unit (CPU), a Digital Signal Processor (DSP), a Microcontroller Unit (MCU) or a Field-Programmable Gate Array (FPGA) in a device.

Note that the data processing device provided in the above-mentioned embodiment is exemplified only by the division of the above-mentioned program modules when performing data processing, and in practical applications, the above-mentioned processing can be distributed to accomplish by different program modules as required, i.e., the internal structure of the data processing device is divided into different program modules to carry out all or part of the above-mentioned processing. In addition, the data processing device and the data processing method provided in the above embodiments belong to the same concept, and the specific implementation process of the data processing device is described in details in the data processing method embodiment and will not be described in details here.

An embodiment of the present disclosure also provides a data processing device, and FIG. 9 is a schematic diagram showing the hardware construction of the data processing device according to an embodiment of the present disclosure. As shown in FIG. 9, the data processing device includes a memory 52, a processor 51, and a computer program stored on the memory 52 and operable on the processor 51, and the processor 51, when executing the program, implements the steps of the data processing method according to the embodiment of the present disclosure.

It will be appreciated that the various components in the data processing device are coupled together by a bus system 53. It will be appreciated that the bus system 53 is used to enable connection communication between these components. The bus system 53 includes, in addition to a data bus, a power bus, a control bus, and a status signal bus. However, for clarity of illustration, the various buses are tagged as the bus system 53 in FIG. 9.

It will be appreciated that memory 52 may be a volatile memory or a nonvolatile memory, and may also include both volatile and nonvolatile memory. Among other things, nonvolatile memory can be Read Only Memory (ROM), Programmable Read-Only Memory (PROM), Erasable Programmable Read-only Memory (EPROM), Electrically Erasable Programmable Read-Only Memory (EEPROM), Ferromagnetic Random Access Memory (FRAM), Flash Memory, Magnetic Surface Memory, Compact Disc Read-Only Memory (CD-ROM); the magnetic surface memory may be a magnetic disk memory or a magnetic tape memory. The volatile memory may be Random Access Memory (RAM), which acts as an external cache. By way of illustration and not limitation, many forms of RAM are available, such as Static Random Access Memory (SRAM), Synchronous Static Random Access Memory (SSRAM), Dynamic Random Access Memory (DRAM), Synchronous Dynamic Random Access Memory (SDRAM), Double Data Rate Synchronous Dynamic Random Access Memory (DDRSDRAM), Enhanced Synchronous Dynamic Random Access Memory (ESDRAM), SyncLink Dynamic Random Access Memory (SLDRAM), and Direct Rambus Random Access Memory (DRRAM). The memory 52 described in the embodiment of the present disclosure is intended to include, but is not limited to, these and any other suitable types of memory.

The methods disclosed in the embodiment of the present disclosure described above may be applied to, or implemented by, a processor 51. Processor 51 may be an integrated circuit chip having signal processing capabilities. In implementation, the steps of the method described above may be performed by integrated logic circuitry in hardware or instructions in software within the processor 51. The processor 51 described above may be a general purpose processor, a DSP, or other programmable logic device, discrete gate or transistor logic device, discrete hardware components, etc. Processor 51 may implement or carry out the various methods, steps, and logic block diagrams disclosed in the embodiment of the present disclosure. A general-purpose processor may be a microprocessor, any conventional processor, etc. The steps of the method disclosed in connection with the embodiment of the present disclosure may be embodied directly as being performed by a hardware decoding processor or performed by a combination of hardware and software modules in the decoding processor. The software module may be located in a storage medium located in the memory 52, and the processor 51 reads the information in the memory 52 to carry out the steps of the aforementioned method in conjunction with its hardware.

In an exemplary embodiment, the data processing device may be implemented by one or more of Application Specific Integrated Circuit (ASIC), DSP, Programmable Logic Device (PLD), Complex Programmable Logic Device (CPLD), FPGA, general-purpose processor, controller, MCU, microprocessor, or other electronic components for performing the aforementioned methods.

In an exemplary embodiment, the embodiment of the present disclosure also provides a computer-readable storage medium, such as a memory 52 including a computer program executable by a processor 51 of a data processing device to carry out the steps of the aforementioned method. The computer readable storage medium may be a memory such as FRAM, ROM, PROM, EPROM, EEPROM, Flash Memory, magnetic surface memory, optical disk, or CD-ROM; or may be various devices including one or any combination of the above memories.

It should be noted that the data processing device as shown in FIG. 9 may also include at least one of the following as actually required: a display used for displaying at least part of processing results obtained after processing by the processor 51; a communication interface used for realizing data transmission between the data processing device and other devices such as mobile phone, tablet computer, server and the like, or for realizing data transmission between components inside the data processing device and the like. The present disclosure is not limited to the structure of a data processing device and may include, but is not limited to, the above-illustrated cases.

The embodiment of the present disclosure provide a computer-readable storage medium having stored thereon a computer program that, when executed by a processor, carries out the steps of the data processing method described in the embodiment of the present disclosure.

An embodiment of the present disclosure also provides a computer program that causes a computer to execute the data processing method described in the embodiment of the present disclosure.

In the several embodiments provided by this disclosure, it is to be understood that the disclosed device and methods may be implemented in other ways. The device embodiments described above are merely illustrative, e.g. the division of the units is merely a logical functional division, and further divisions are possible in practical implementations, e.g. multiple units or components may be combined, or may be integrated into another system, or some features may be omitted, or not performed. In addition, the components shown or discussed may be coupled to one another, either directly or communicatively, via some interfaces, devices, or units.

The elements described above as separate elements may or may not be physically separate, and the elements shown as elements may or may not be physical elements, i.e. may be located in one place or assigned over a plurality of network elements; some or all of the elements may be selected to achieve the objectives of the inventive arrangements according to practical requirements.

In addition, each functional unit in each embodiment of the present disclosure can be fully integrated in one processing unit, each unit can be separately used as one unit, or two or more units can be integrated in one unit; the integrated units described above can be implemented either in hardware or in hardware plus software functional units.

A person skilled in the art will appreciate that: all or part of the steps for implementing the method embodiments described above may be performed by hardware associated with program instructions, which may be stored in a computer readable storage medium, which when executed carries out the steps including the method embodiments described above; the aforementioned storage medium includes: mobile storage devices, ROMs, RAMs, magnetic or optical disks, and various media on which program code may be stored.

Alternatively, the above-mentioned integrated units of the present disclosure may also be stored in a computer-readable storage medium if implemented in the form of software functional modules and sold or used as an independent product. Based on this understanding, the technical aspects of the embodiment of the present disclosure, in essence or in part contributing to the prior art, may be embodied in the form of a software product stored in a storage medium including instructions for causing a computer device (which may be a personal computer, a server, or a network device, etc.) to carry out all or part of the methods described in the various embodiments of the present disclosure. The aforementioned storage medium includes: mobile storage devices, ROMs, RAMs, magnetic or optical disks, and various media on which program code may be stored.

While the foregoing is directed to a particular embodiment of the present disclosure, the scope of the present disclosure is not limited thereto, and variations and substitutions will readily occur to a person skilled in the art and are intended to be within the scope of the present disclosure. Therefore, the scope of protection of this disclosure should be determined with reference to the claims.

What is claimed is:

1. A data processing method, comprising:
acquiring visit data of a target customer in a group of customers in a target area, wherein the visit data includes location data for reflecting a location of the target customer and a time for generating the location data;
determining a residence time duration of the target customer in the target area according to the time for generating the location data;
determining data of interest of the target customer based on the residence time duration; and
determining the data of interest of the target customer as data of interest of the group of customers.

2. The method according to claim 1, wherein acquiring the visit data of the target customer in the group of customers in the target area comprises:
acquiring the visit data of the target customer; and
acquiring, from the visit data of the target customer, visit data the location data of which indicates that the target customer is located in the target area, as the visit data of the target customer in the target area.

3. The method according to claim 2, wherein the visit data comprises message data,
acquiring the visit data of the target customer comprises:
acquiring at least one target message data carrying an identification of the target customer,
acquiring, from the visit data of the target customer, the visit data the location data of which indicates that the target customer is located in the target area, as the visit data of the target customer in the target area, comprises:
extracting the location data of the target customer from the target message data; and
taking the target message data in which the location data is within the target area as the visit data of the target customer in the target area.

4. The method according to claim 1, wherein the visit data comprises a personal image of the target customer;
acquiring the visit data of the target customer comprises:
acquiring at least one frame of personal image of the target customer captured by an image capturing device;
acquiring, from the visit data of the target customer, the visit data the location data of which indicates that the target customer is located in the target area, as the visit data of the target customer in the target area, comprises:
acquiring a deployment location of the image capturing device and a location of the target customer in the personal image;
determining location data of the location of the target customer according to the deployment location of the image capturing device and the location of the target customer in the personal image; and
taking a personal image corresponding to which the location data is within the target area as the visit data of the target customer in the target area.

5. The method according to claim 3, wherein acquiring the at least one target message data carrying the identification of the target customer comprises:
acquiring the at least one target message data carrying the identification of the target customer from cached message data corresponding to a plurality of customers; or
receiving message data corresponding to the plurality of customers and discarding message data carrying no identification of the target customer from the message data corresponding to the plurality of customers, so as to acquire the at least one target message data carrying the identification of the target customer.

6. The method according to claim 3, wherein the at least one target message data comprises a plurality of target message data, and determining the residence time duration of the target customer in the target area according to the time for generating the location data comprises:
determining at least two target message data in the plurality of target message data, wherein the at least two target message data include first target message data and second target message data, and the time for generating the location data in the first target message data is earlier than the time for generating the location data in the second target message data;
determining the residence time duration according to the time for generating the location data in the first target message data and the time for generating the location data in the second target message data,
wherein the location data carried by the first target message data is different from the location data carried by a previous target message data adjacent to the first target message data, the location data carried by the second target message data is different from the location data carried by a next target message data adjacent to the second target message data, and the location data carried by the first target message data is the same as the location data carried by the second target message data.

7. The method according to claim 3, wherein the at least one target message data comprises a plurality of target message data including first message data, and determining the residence time duration of the target customer in the target area according to the time for generating the location data comprises:
continuously obtaining the plurality of target message data corresponding to the target customer, and determining the first location data of the target customer respectively based on each target message data in the plurality of target message data;
in the case where at least part of the first location data in a plurality of the first location data indicates that the target customer is located in the target area, determining a plurality of first message data corresponding to the at least part of the first location data; and
determining the residence time duration of the target customer in the target area based on a time interval of two adjacent first message data in the plurality of first message data.

8. The method according to claim 7, wherein determining the residence time duration of the target customer in the target area based on the time interval of the two adjacent first message data in the plurality of first message data comprises:
determining, from the plurality of first message data, at least part of the first message data in which the time interval of two adjacent first message data is smaller than a first threshold value, and determining the residence time duration based on the time interval of two adjacent first message data in the at least part of the first message data.

9. The method according to claim 1, wherein there are a plurality of target areas, each target area characterizes an area corresponding to one target object, and determining the data of interest of the target customer based on the residence time duration comprises:
obtaining the residence time duration of the target customer in each target area respectively, wherein the residence time duration includes a residence time duration of the target customer in the target area corresponding to at least one time period; and
ranking the residence time durations corresponding to the plurality of target areas, and determining first data of interest of the target customer based on the ranking result, wherein the first data of interest characterizes the extent to which a plurality of target objects are concerned by the target customer.

10. The method according to claim 1, wherein there are a plurality of target areas, each target area characterizes an area corresponding to one target object, and the method further comprises:
accumulating the residence time durations of the target customers in a plurality of groups of customers in the target area within a preset time range, to obtain accumulated residence time durations of a plurality of target customers in the target area; and
ranking the accumulated residence time durations corresponding to the plurality of target areas, and determining second data of interest based on the ranking result, wherein the second data of interest respectively characterizes the extent to which the target object corresponding to each of the plurality of target areas is concerned.

11. The method according to claim 1, wherein the method further comprises:
adding, based on the data of interest, a tag to the target customer and/or a group of customers to which the target customer belongs.

12. The method according to claim 1, wherein after determining of the data of interest of the target customer as the data of interest of the group of customers, the method further comprises:
receiving an access request for data of interest of a plurality of groups of customers; and
in response to the access request, presenting the data of interest of the plurality of groups of customers through a display screen according to a presentation mode indicated by the access request.

13. A data processing device, comprising:
a processor; and
a memory configured to store processor-executable instructions,
wherein the processor is configured to invoke the instructions stored in the memory, so as to:
acquire visit data of a target customer in a group of customers in a target area, wherein the visit data includes location data for reflecting a location of the target customer and a time for generating the location data,
determine a residence time duration of the target customer in the target area according to the time for generating the location data,
determine data of interest of the target customer based on the residence time duration, and
determine the data of interest of the target customer as data of interest of the group of customers.

14. The device according to claim 13, wherein acquiring the visit data of the target customer in the group of customers in the target area comprises:
acquiring the visit data of the target customer; and
acquiring, from the visit data of the target customer, visit data the location data of which indicates that the target customer is located in the target area, as the visit data of the target customer in the target area.

15. The device according to claim 14, wherein the visit data comprises message data, and
acquiring the visit data of the target customer comprises:
acquiring at least one target message data carrying an identification of the target customer;
extracting the location data of the target customer from the target message data; and
taking the target message data in which the location data is within the target area as the visit data of the target customer in the target area.

16. The device according to claim 13, wherein the visit data comprises a personal image of the target customer, and
acquiring the visit data of the target customer comprises:
acquiring at least one frame of personal image of the target customer captured by an image capturing device;
acquiring a deployment location of the image capturing device and a location of the target customer in the personal image;
determining location data of the location of the target customer according to the deployment location of the image capturing device and the location of the target customer in the personal image; and
taking a personal image corresponding to which the location data is within the target area as the visit data of the target customer in the target area.

17. The device according to claim 15, wherein acquiring the at least one target message data carrying the identification of the target customer comprises:
acquiring the at least one target message data carrying the identification of the target customer from cached message data corresponding to a plurality of customers; or
receiving message data corresponding to the plurality of customers and discarding message data carrying no identification of the target customer from the message data corresponding to the plurality of customers, so as to acquire the at least one target message data carrying the identification of the target customer.

18. The device according to claim 15, wherein the at least one target message data comprises a plurality of target message data, and
determining the residence time duration of the target customer in the target area according to the time for generating the location data comprises:
determining at least two target message data in the plurality of target message data, wherein the at least two target message data include first target message data and second target message data, and the time for generating the location data in the first target message data is earlier than the time for generating the location data in the second target message data;
determining the residence time duration according to the time for generating the location data in the first target message data and the time for generating the location data in the second target message data,
wherein the location data carried by the first target message data is different from the location data carried by a previous target message data adjacent to the first target message data, the location data carried by the second target message data is different from the location data carried by a next target message data adjacent to the second target message data, and the location data carried by the first target message data is the same as the location data carried by the second target message data.

19. The device according to claim 15, wherein the at least one target message data comprises a plurality of target message data including first message data, and
determining the residence time duration of the target customer in the target area according to the time for generating the location data comprises:
continuously obtaining the plurality of target message data corresponding to the target customer, and determining the first location data of the target customer respectively based on each target message data in the plurality of target message data;
in the case where at least part of the first location data in a plurality of the first location data indicates that the target customer is located in the target area, determining a plurality of first message data corresponding to the at least part of the first location data; and
determining the residence time duration of the target customer in the target area based on a time interval of two adjacent first message data in the plurality of first message data.

20. A non-transitory computer readable storage medium having stored thereon a computer program which, when executed by a processor, the processor is caused to perform the operations of:
acquiring visit data of a target customer in a group of customers in a target area, wherein the visit data includes location data for reflecting a location of the target customer and a time for generating the location data;
determining a residence time duration of the target customer in the target area according to the time for generating the location data;
determining data of interest of the target customer based on the residence time duration; and
determining the data of interest of the target customer as data of interest of the group of customers.
